(19) United States
(12) Patent Application Publication
(10) Pub. No.: US 2009/0112999 A1
(43) Pub. Date: Apr. 30, 2009

(54) System and Method for Handling E-Mail Attachments in Data Processing Systems

(76) Inventor: Richard Nicholas, Round Rock, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/924,643

(22) Filed: Oct. 26, 2007

(51) Int. Cl. G06F 15/16

(52) U.S. Cl. 709/206

(57) ABSTRACT

A system and method for handling e-mail attachments in a data processing system. A client receives at least one message in a message database stored in a system memory, wherein the at least one message includes at least one attached file. The client displays a main preview of the at least one message, wherein the main preview of the at least one message includes an indicia that represents the at least one attached file. The client expands the main preview of the at least one message into a first sub-preview and a second sub-preview, wherein the first sub-preview represents the at least one message, and wherein the second sub-preview represents the at least one attached file. The client selects the second sub-preview to perform a function on the at least one attached file independent of the at least one message. The client performs the function on the at least one attached file independent of the at least one message.

### BACKGROUND OF THE INVENTION

1. Technical Field

The present invention relates in general to data processing systems, and particularly, to managing data with data processing systems. Still more particularly, the present invention relates to a system and method for simplifying data management within a data processing system.

2. Description of the Related Art

Electronic mail (e-mail) is a method of composing, storing, sending, and receiving messages over a network. As well-known in the art, e-mail clients have the capability of attaching files to e-mail messages. These files are referred to as “attachments”. Attachments vary in size, from a few kilobytes for simple text files to tens or hundreds of megabytes for presentation (e.g., PowerPoint®), audio, and video files. As attachment sizes increase, more bandwidth is required to send e-mail messages. Also, the storage of each e-mail message requires more memory.

Also, as well-known in the art, e-mail clients enable users to easily reply to received messages with a “reply” option, which often copies the content of a prior message into a reply message. The user can subsequently add additional text to the reply message. The content of the prior message is included in the reply message for the convenience of the original sender. The sender does not have to retrieve the prior message to understand the content of the reply message.

A side effect of the “reply” option is that all the content of the prior message is included in the reply message, including any attachments, which requires more bandwidth and storage space. The increased consumption of bandwidth and storage space is exacerbated by chains of e-mail conversations where two or more users continue to reply to an e-mail that includes attachments. Each reply adds to the conversation, but users frequently neglect to delete the attachments.

Without active management by the owner of an e-mail account, e-mail databases can quickly consume gigabytes or even tens of gigabytes of storage space. Bloated e-mail databases introduce two problems: (1) the larger and more bloated an e-mail database becomes, the slower normal operations of an e-mail client utilizing that e-mail database become; and (2) the user is at risk of exceeding the size limits on e-mail databases imposed by many companies and universities. These companies and universities are forced to impose size limits due to the cost-prohibitive nature of backing up and managing e-mail accounts for thousands of users when those e-mail storage requirements can be exceedingly large due to unmanaged attachments.

Users cannot merely delete e-mail messages with attachments because those e-mails often include important discussion in addition to the attachments. Therefore, people are forced to manage their attachments manually to keep their e-mail database to a manageable size. As well-known in the art, there are two ways of managing an e-mail database:

(1) Users could move e-mails from their main e-mail database, which is backed up by the company or university servers, to a local archive database on the user's local hard drive. However, the localization of the e-mail database merely moves the problem to a local hard drive. The local archive database will quickly get bloated with attachments that are either no longer needed or would best reside in a more organized place, like a project folder related to the attachments. The ideal location for the attachments is not an e-mail archive where the attachments are difficult to locate, but in a project folder stored within the file system hierarchy. Also, the local archive database is not automatically backed up by the company or university servers, which makes the local archive database more prone to data loss.

(2) Users could actively manage the attachments in their e-mail database. User-management of e-mail attachments involves moving the attachments to an appropriate place on a local or network drive, such as a project folder that relates to the attachments. Also, the user must open the e-mail message, drag the attachments to a project folder to create a new copy, and then delete the attachments from the e-mail message, which can be a very time-consuming process, especially if the user must repeat the process many times for multiple e-mail messages.

Therefore, there is a need for a system and method for addressing the aforementioned limitations of the prior art.

### SUMMARY OF THE INVENTION

The present invention includes a system and method for handling e-mail attachments in a data processing system. A client receives at least one message in a message database stored in a system memory, wherein the at least one message includes at least one attached file. The client displays a main preview of the at least one message, wherein the main preview of the at least one message includes an indicia that represents the at least one attached file. The client expands the main preview of the at least one message into a first sub-preview and a second sub-preview, wherein the first sub-preview represents the at least one message, and wherein the second sub-preview represents the at least one attached file. The client selects the second sub-preview to perform a function on the at least one attached file independent of the at least one message. The client performs the function on the at least one attached file independent of the at least one message.

The above, as well as additional purposes, features, and advantages of the present invention will become apparent in the following written detailed description.

### BRIEF DESCRIPTION OF THE FIGURES

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying figures, wherein:

FIG. 1A is a block diagram illustrating an exemplary network in which an embodiment of the present invention may be implemented;

FIG. 1B is a block diagram depicting an exemplary data processing system in which an embodiment of the present invention may be implemented;

FIG. 2A is a block diagram showing exemplary contents of a system memory of a server in which an embodiment of the present invention may be implemented;

FIG. 2B is a block diagram illustrating exemplary contents of a system memory of a client in which an embodiment of the present invention may be implemented;

FIGS. 3A-3D depict an exemplary e-mail client interface according to an embodiment of the present invention; and

FIGS. 4A-4B are high-level logical flowcharts illustrating an exemplary method for handling e-mail attachments in data processing systems.

### DETAILED DESCRIPTION OF AN ILLUSTRATIVE EMBODIMENT

The present invention includes a system and method for handling e-mail attachments in a data processing system. A client receives at least one message in a message database stored in a system memory, wherein the at least one message includes at least one attached file. The client displays a main preview of the at least one message, wherein the main preview of the at least one message includes an indicia that represents the at least one attached file. The client expands the main preview of the at least one message into a first sub-preview and a second sub-preview, wherein the first sub-preview represents the at least one message, and wherein the second sub-preview represents the at least one attached file. The client selects the second sub-preview to perform a function on the at least one attached file independent of the at least one message. The client performs the function on the at least one attached file independent of the at least one message.

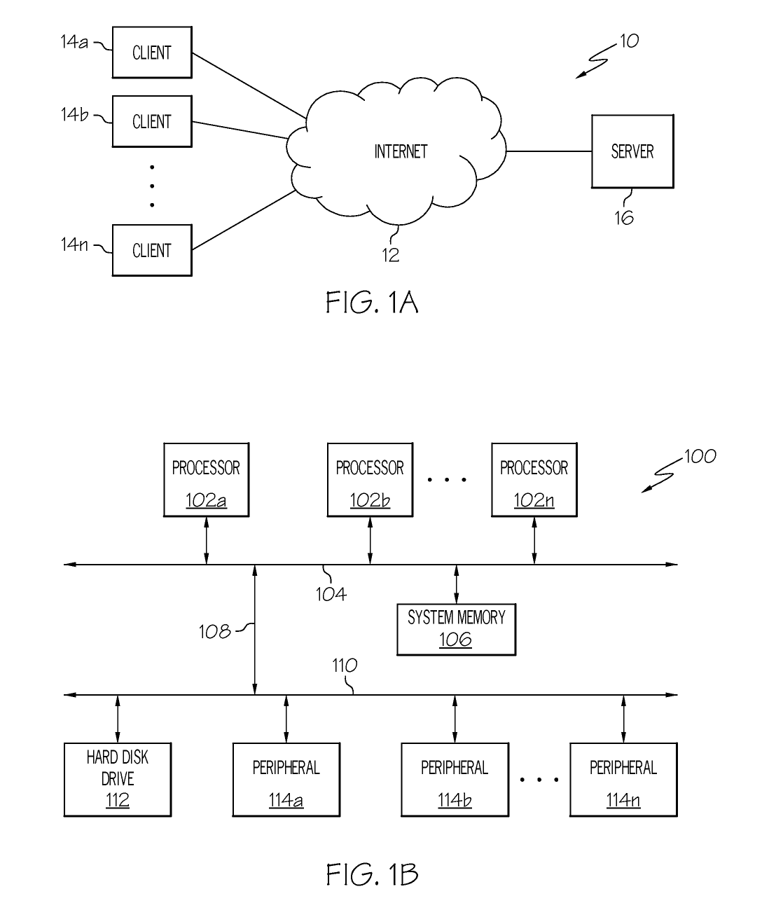

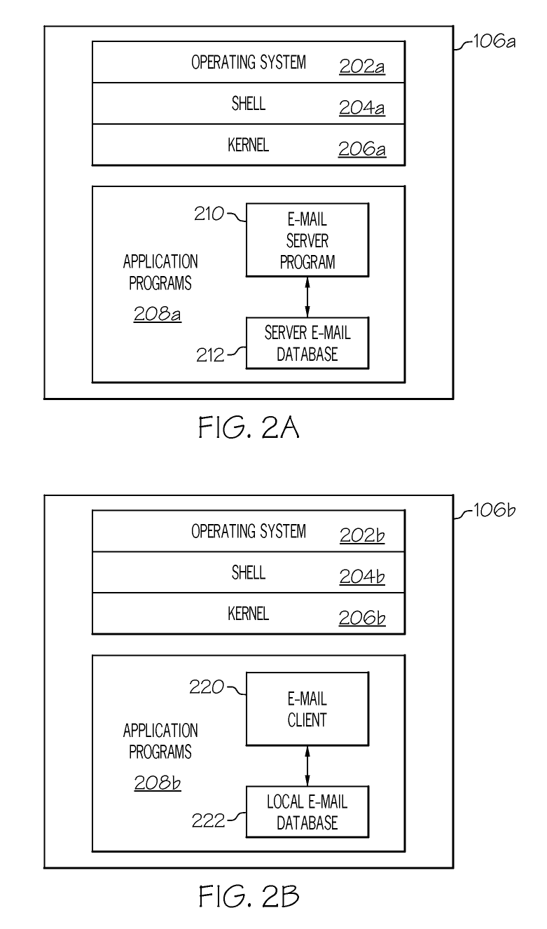

Referring now to the figures, and in particular, referring to FIG. 1A, there is illustrated a block diagram depicting an exemplary network 10 in which an embodiment of the present invention may be implemented. As illustrated, network 10 includes a collection of clients 14a-14n, Internet 12, and server 16. Clients 14a-14n are coupled to server 16 via Internet 12. While Internet 12 is utilized to couple clients 14a-14n to server 16, those with skill in the art will appreciate that a local-area network (LAN) or wide-area network (WAN) utilizing Ethernet, IEEE 802.11x, or any communications protocol may be utilized. Clients 14a-14n implement e-mail clients 220 (FIG. 2B) coupled to local e-mail databases 222 (FIG. 2B) and server 16 implements an e-mail server program 210 (FIG. 2A). Clients 14a-14n and server 16 are discussed in more detail in conjunction with FIG. 1B. Those with skill in the art will appreciate that exemplary network 10 may include other components such as routers, firewalls, etc. that are not germane to the discussion of the present network and will not be discussed further herein. Those with skill in the art will also appreciate that the present invention may include any number of servers and clients coupled in any network configuration and is in no way limited to the general network configuration illustrated in FIG. 1A.

FIG. 1B is a block diagram depicting an exemplary data processing system 100 which may be utilized to implement clients 14a-14n and server 16 as shown in FIG. 1A. As illustrated, exemplary data processing system 100 includes a collection of processors 102-102n that are coupled to a system memory 106 via a system bus 104. System memory 104 may be implemented by dynamic random access memory (DRAM) modules or any other type of random access memory (RAM) module. Mezzanine bus 108 couples system bus 104 to peripheral bus 110. Coupled to peripheral bus 110 is a hard disk drive 112 for mass storage and a collection of peripherals 114a-114n, which may include, but are not limited to: optical drives, other hard disk drives, printers, input devices (e.g., a keyboard and/or mouse, etc.), and the like.

Those with skill in the art will appreciate that data processing system 100 can include many additional components not specifically illustrated in FIG. 1B. Because such additional components are not necessary for an understanding of the present invention, they are not illustrated in FIG. 1B or discussed further herein. It should be understood, however, that the enhancements to data processing system 100 provided by the present invention are applicable to data processing systems of any system architecture and are in no way limited to the generalized multi-processor architecture or symmetric multi-processing (SMP) architecture illustrated in FIG. 1B.

FIG. 2A-2B are block diagrams illustrating exemplary contents of system memory 106a of server 16 and system memory 106b of clients 14a-14n, according to an embodiment of the present invention. As shown, system memories 106a-106b include operating systems 202a-202b, which further include shells 204a-204b (as they are called in UNIX®) for providing transparent user access to resources such as application programs 208a-208b. Generally, shells 204a-204b are programs that provide an interpreter and an interface between the user and operating system 202a. More specifically, shells 204a-204b execute commands that are entered into a command line user interface or a file. Thus, shells 204a-204b, also called command processors in Windows®, are generally the highest level of the operating system software hierarchy and serve as command interpreters. The shells provide a system prompt, interpret commands entered by keyboard, mouse, or other user input media, and send the interpreted command(s) to the appropriate lower levels of the operating system (e.g., kernels 206a-206b) for processing. Note that while shells 204a-204b are text-based, line-oriented user interfaces, the present invention will support other user interface modes, such as graphical, voice, gestural, and the like equally well.

As illustrated, operating systems 202a-202b also include kernels 206a-206b. Kernels 206a-206b include lower levels of functionality for operating systems 202a-202b and application programs 208a-208b, including memory management, process and task management, disk management, and mouse and keyboard management. Application programs 208a-208b can include a browser, utilized for access to Internet 12 (FIG. 1A), word processors, spreadsheets, and other application programs.

Referring to FIG. 2A, application programs 208a includes e-mail server program 210, which coordinates the receipt, storing, and forwarding of e-mail messages from clients 14a-14b (FIG. 1A). While those with skill in the art will appreciate that server 16 (FIG. 1A) and e-mail server program 210 may utilize simple mail transfer protocol (SMTP) and/or post office protocol (POP) for the sending and receipt of e-mail messages, those with skill in the art will appreciate that any mail transfer protocol may be utilized. Server 16 may be implemented as a mail transfer agent (MTA), mail exchange server, and/or a corporate e-mail system.

If server 16 is a MTA, the e-mail message is forwarded to a mail exchange server (not pictured) coupled to Internet 12. If server 16 is a mail exchange server, server 16 receives e-mails forwarded from an MTA. Implemented as a corporate e-mail system, server 16 would perform both sending and receiving functions. E-mail server program 210 interfaces with server e-mail database 212, which catalogs and archives e-mail messages received from clients 14a-14n.

Referring to FIG. 2B, application programs 208b includes e-mail client 220 and local e-mail database 222. A user logs on to server 16 via e-mail client 220 to retrieve e-mail messages. When the e-mail messages are retrieved, the e-mail messages and any corresponding attachments are stored in local e-mail database 222. Also, according to an embodiment of the present invention, a user may opt to store copies of the e-mail messages within server e-mail database 212 (FIG. 2A) even after e-mail client 220 retrieves the e-mail messages from server e-mail database 212.

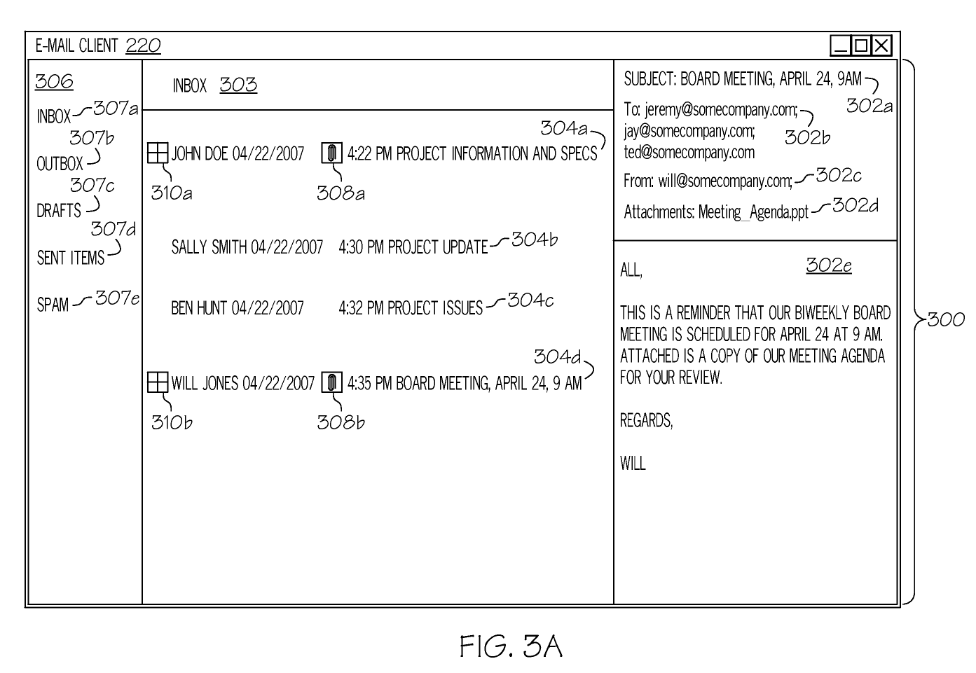

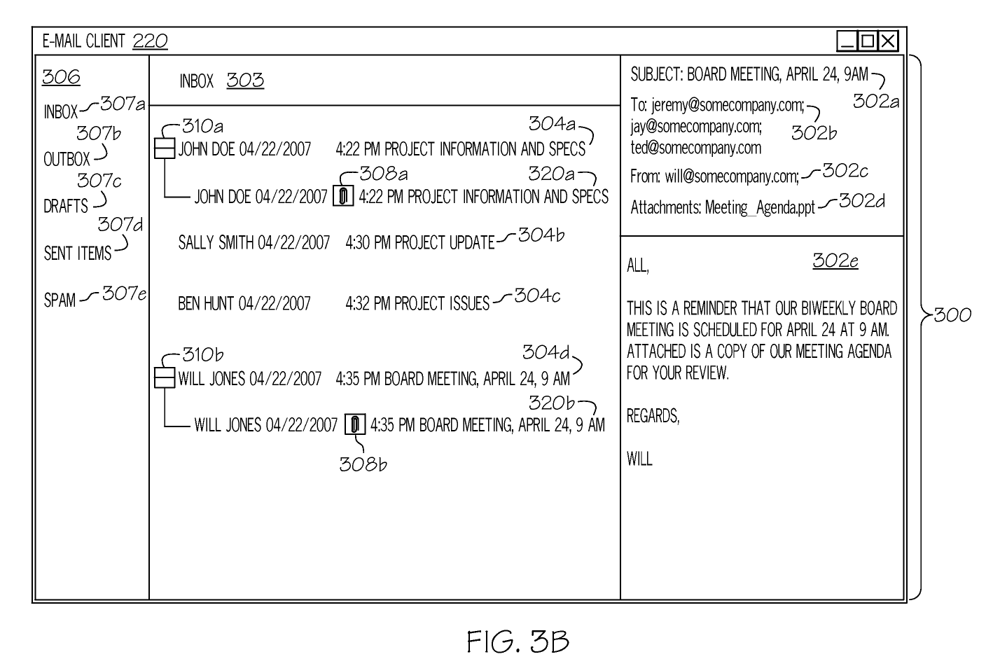

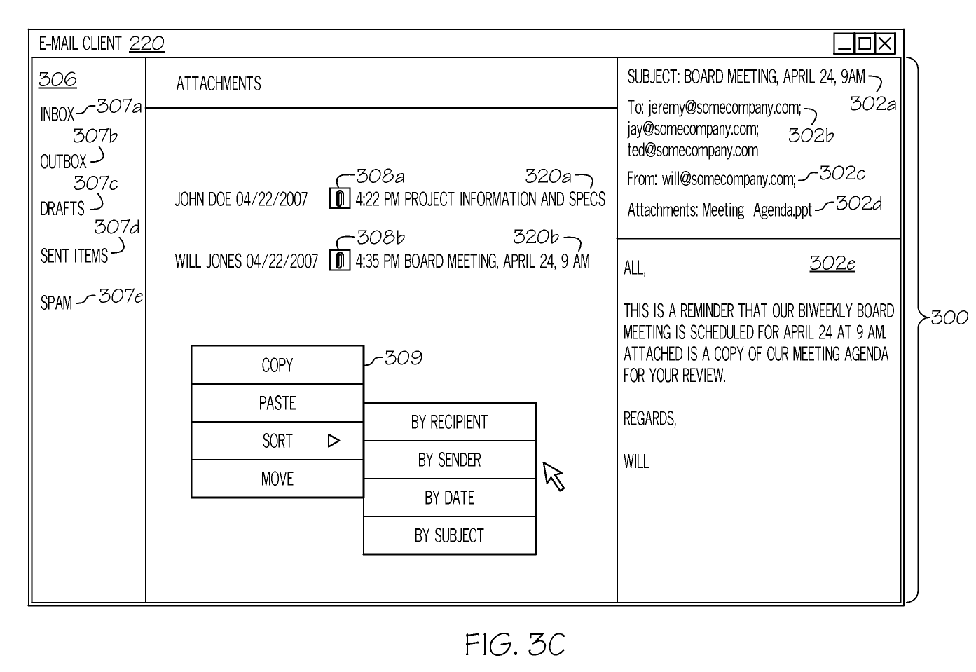

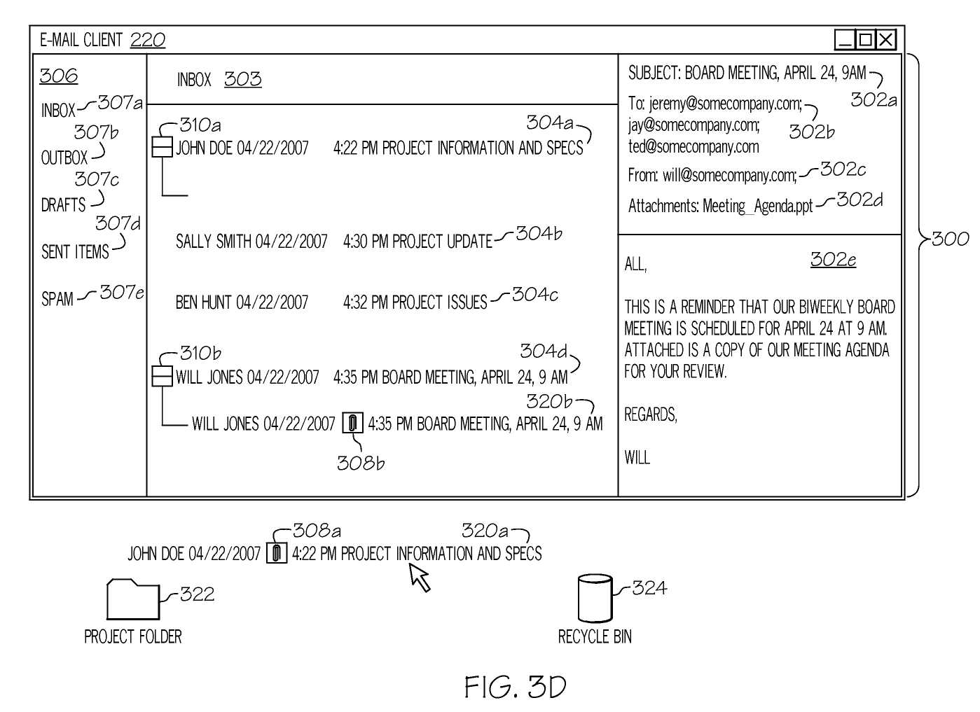

FIG. 3A is a pictorial representation of an exemplary user interface of e-mail client 220 according to an embodiment of the present invention. Preview window 300 enables a user to preview a selected e-mail message. As shown, preview window 300 includes a variety of components. Subject line 302a indicates the subject matter of the e-mail message. “To” line 302b indicates the recipient(s) of the e-mail message. “From” line 302c indicates the sender of the message. Attachments line 302d notifies the user of any attached files (hereinafter referred to as “attachments”) to the e-mail message. Message text window 302e displays at least part of the previewed message.

E-mail folders window 306 displays default and/or user-created folders utilized by the user to categorize e-mail messages within local e-mail database 222 for ease of access. For example, e-mail messages may be categorized within the “Inbox” folder 307a (received e-mail messages), “Outbox” folder 307b (e-mail messages to be sent), “Drafts” folder 307c (incomplete e-mail message), “Sent Items” folder 307d (e-mail messages that have been sent), and “Spam” folder 307e (junk e-mail). As shown in FIG. 3A, “inbox” folder 307a has been selected for display within e-mail client 220 and displays corresponding inbox 303.

Inbox 303 includes a collection of received e-mail message indicators 304a-304d. However, also as depicted, e-mail message indicators 304a and 304d include two other components: attachment icon 308a-308b and expansion boxes 310a-310b. Attachment icons 308a-308b indicate that the corresponding e-mail messages represented by e-mail message indicators 304a and 304d include associated attachments.

According to an embodiment of the present invention, assuming that a user is interacting with e-mail client 220 utilizing a two-button mouse (e.g., left and right mouse buttons), the user may utilize the left mouse button to drag the attachment icons 308a-308b to a folder (e.g., project folder 322, FIG. 3D) stored elsewhere in system memory 106b (FIG. 1B), hard disk drive 112 (FIG. 1B), or any permanent or removable storage media coupled to network 10 (FIG. 1A). E-mail client 220 copies the attachments represented by attachment icons 308a-308b to the folder and leaves the attachments stored within local e-mail database 222. If the user utilizes the right mouse button to drag attachment icons 308a-308b to a folder, e-mail client 220 copies the attachments represented by attachment icons 308a-308b to the folder and deletes the attachments from local e-mail database 222, but leaves the body of the associated e-mail in local e-mail database 222. If the user utilizes either the left or right mouse button to drag attachment icons 308a-308b to a folder that includes files slated for deletion (e.g., recycle bin 324, FIG. 3D), e-mail client 220 deletes the attachments from local e-mail database 222, but leaves the body of the associated e-mail in local e-mail database 222. The folder that includes files slated for deletion varies depending on implementation. For example, Microsoft Windows® XP refers to the folder as a “recycle bin”. Other operating systems refer to the folder as a “trash can”.

E-mail message indicators 304a and 304d also include expansion boxes 310a-310b. Expansion boxes enable a user to separate an associated e-mail message indicator into two lines of indicators, the original e-mail message indicator and a separate attachment indicator, as illustrated and discussed in more detail in conjunction with FIG. 3B. In an embodiment of the present invention, expansion boxes are assigned to any e-mail messages that include an associated attachment.

FIG. 3B is another pictorial representation of an exemplary user interface of e-mail client 220 according to an embodiment of the present invention. As indicated, e-mail message indicators 304a and 304d of FIG. 3A have been separated into two indicator lines: an e-mail message indicator 304a and 304d and an attachment indicator 320a and 320b.

The first line, which are the e-mail message indicators, represent the corresponding e-mail message text, minus any attachments. Assuming the user is interacting with e-mail client 220 utilizing a two-button mouse (e.g., left and right mouse buttons), and the user selects the first line, such as e-mail message indicator 304a, the corresponding e-mail message test is displayed in preview window 300. In an embodiment of the present invention, if the user deletes e-mail message indicator 304a, both the corresponding e-mail message text and the associated attachment will be deleted from local e-mail database 222. Attachment indicator 320a will also be deleted.

The user can also select an attachment indicator (e.g., attachment indicators 320a-320b) to perform actions on the attachment without affecting the corresponding e-mail message text, as illustrated in FIG. 3D. For example, if the user utilizes the left mouse button to drag attachment indicator 320a-320b to a folder (e.g., project folder 322), e-mail client 220 copies the attachment to the folder and leaves the attachment stored within local e-mail database 222. If the user utilizes the right mouse button to drag an attachment indicator 320a-320b to a folder, e-mail client 220 copies the attachment to the folder and deletes the attachment from local e-mail database 222. The e-mail message corresponding to e-mail message indicator 318 remains stored in local e-mail database 222. If the user utilizes either the left or right mouse button to drag attachment indicator 318 to a folder that includes files slated for deletion (e.g., recycle bin 324), e-mail client 220 deletes the attachment from local e-mail database 222.

By selecting an expansion box and separating an e-mail message indictor into two separate lines, a user may perform a variety of actions, including, but not limited to: deleting attachments by merely selecting the attachment indicator and pressing a “delete” key on a keyboard; selecting or checking several attachment indicators (associated to different e-mail indicators) at once and performing the same operation (e.g., copy, move, delete, etc.) on all of the attachment indicators at once; sorting the e-mail folder (e.g., folders in e-mail folders window 306) by attachment indicators (e.g., have all attachment indicators displayed together so that a user can easily select more than one of them for performing the same operation (e.g., copy, move, delete, etc.)), as illustrated in FIG. 3C. FIG. 3C depicts e-mail client 220 displaying only attachment indicators 320a-320b after a user has requested a sort of the e-mail folder by attachment indicators. Also, as shown, selection menu 309 enables a user to copy, paste, select sort options (including, but not limited to sorting by recipient, sender, date, and subject), and move attachment indicators 320a-320b.

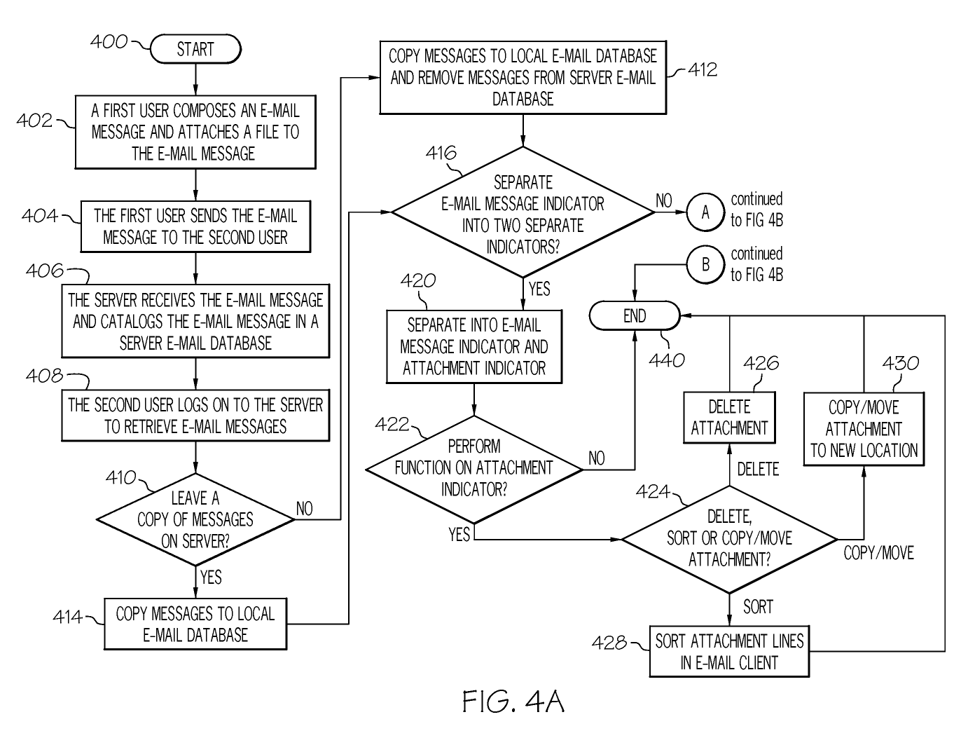

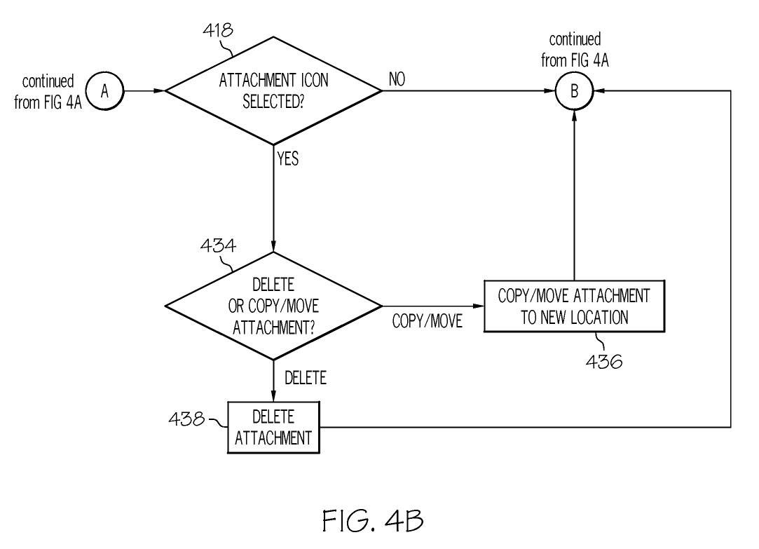

FIGS. 4A-4B are high-level logical flowcharts illustrating an exemplary method for handling e-mail attachments in data processing systems according to an embodiment of the present invention. Referring to FIG. 4A, the process begins at step 400 and continues to step 402, which illustrates a first user accessing a client (e.g., one of clients 14a-14n of FIG. 1A) to compose an e-mail message and attaching an attachment file to that e-mail message utilizing e-mail client 220 (FIG. 2B). The process continues to step 404, which depicts the first user sending the e-mail message to server 16 (FIG. 1A) via Internet 12 (FIG. 1A). The message is addressed to a second user.

The process proceeds to step 406, which shows server 16 receiving the e-mail message and cataloging the e-mail message (and associated attachment(s)) in server e-mail database 212. The process continues to step 408, which illustrates a second user accessing a second client (e.g., one of clients 14a-14n) to log into server 16 to retrieve e-mail messages addressed to the second user.

The process continues to step 410, which illustrates server 16 determining if the second client has selected an option within e-mail client 220 to leave a copy of any retrieved e-mail messages and any associated attachments stored in server e-mail database 212. If the second client has not selected an option to leave a copy of any retrieved e-mail messages and any associated attachments stored in server e-mail database 212, the process proceeds to step 412, which depicts server 16 copying any messages addressed to the second user to local e-mail database 222 located in the system memory (e.g., system memory 106b) of the second client and removing any copies of the messages and any associated attachments addressed to the second user from server e-mail database 212. The process then continues to step 416.

Returning to step 410, if the second client has selected an option to leave a copy of any retrieved e-mail messages and any associated attachments stored in server e-mail database 212, the process proceeds to step 414, which shows server 16 copying e-mail messages and associated attachments addressed to the second user to local e-mail database 222.

The process continues to step 416, with illustrates e-mail client 220 determining if a user has indicated that an e-mail message indicator (e.g., e-mail message indicators 304a-304d) is to be separated into two separate indicator lines: an e-mail message indicator and an attachment indicator. If the user has not indicated to e-mail client 220 to separate an e-mail message indicator into two separate indicator lines, the process continues to FIG. 4B via marker A.

Referring to FIG. 4B, the process continues to step 418, which shows e-mail client 220 determining if an attachment icon (e.g., attachment icons 308a-308b) has been selected. If an attachment icon has been selected, the process continues to step 434, which illustrates e-mail client 220 determining if the attachment associated with the selected attachment icon is to be deleted or copied/moved from local e-mail database 222. If the attachment associated with the selected attachment icon is to be copied/moved from local e-mail database 222, the process continues to step 436, which illustrates e-mail client 220 copying/moving the attachment from local e-mail database 222 to a new location within system memory 106 (FIG. 1B), hard disk drive 112 (FIG. 1B), to another location within network 10 (FIG. 1A), or to another type of external storage including, but not limited to a universal serial bus (USB) thumb drive, CD-ROM, diskette, and the like. The process then proceeds to back to FIG. 4A via marker B and ends, as illustrated by step 440.

If the attachment associated with the selected attachment icon is to be deleted from local e-mail database 222, the process continues to step 438, which depicts e-mail client 220 deleting the attachment from local e-mail database 222. The process then continues back to FIG. 4A via marker B and ends, as shown by step 440.

Returning to step 416 of FIG. 4A, if the user has indicated to e-mail client 220 to separate an e-mail message indicator into two separate indicator lines, the process continues to step 420, which illustrates e-mail client separating the selected e-mail message indicator into an e-mail message indicator and an attachment indicator (e.g., e-mail message indicator 304a and attachment indicator 320a, FIG. 3B). The process continues to step 422, which illustrates e-mail client 220 determining if e-mail client 220 has received instructions to perform some function on the attachment indicator, as depicted in step 422. If not, the process proceeds to step 440, which shows the process ending.

If e-mail client 220 has received instructions to perform some function on the attachment indicator, the process continues to step 424, which illustrates e-mail client 220 determining the type of function to be performed on the attachment indicator (and the associated attachment file). If a user instructs e-mail client 220 to delete the attachment file by selecting the attachment indicator and selecting the “delete” option, the process continues to step 426, which depicts e-mail client 220 deleting the attachment from local e-mail database 222. Returning to step 424, if the user instructs e-mail client 220 to copy/move the attachment file to a new location by selecting the “copy to” option, the process proceeds to step 430, which illustrates e-mail client 220 copying the attachment file to a selected new location. As previously discussed, the new location may include hard disk drive 112 (FIG. 1B), system memory 106 (FIG. 1B), any other location on network 10 (FIG. 1A), or to another type of external storage including, but not limited to a universal serial bus (USB) thumb drive, CD-ROM, diskette, and the like. Also, in another embodiment of the present invention, each attachment indicator represents all of the attachments associated with a particular e-mail message. Any function performed on the attachment indicator may affect all attachments associated with a particular e-mail message. Also, the abovementioned options may be performed on more than one attachment indicators by selecting more than one line in the e-mail client 220. For example, in the Windows® operating system, a user can select more than one attachment indicator by depressing the “CTRL” key and utilizing a mouse to click on several attachment indicators. Also, a user can select more than one attachment indicator by utilizing the “SHIFT” key to select a block of adjacent attachment indictors. The process then continues to step 440, which shows the process ending.

Returning to step 424, if the user instructs e-mail client 220 to sort attachment indicators, the process continues to step 428, which shows e-mail client 220 sorting and displaying only the attachment indicators in the current mailbox (FIG. 3C). By sorting and displaying only the attachment indicators in the current mailbox, the user may perform a function (e.g., delete, copy/move, etc.) on all of the displayed and selected attachment indicators at once. In another embodiment of the present invention, a user may also sort the attachment indictors corresponding to the size of the associated attachment files. Also, the abovementioned options may be performed on more than one attachment indicators by selecting more than one line in the e-mail client 220. For example, in the Windows® operating system, a user can select more than one attachment indicator by depressing the “CTRL” key and utilizing a mouse to click on several attachment indicators. Also, a user can select more than one attachment indicator by utilizing the “SHIFT” key to select a block of adjacent attachment indictors. The process then continues to step 440, which illustrates the process ending.

As discussed, the present invention includes a system and method for handling e-mail attachments in a data processing system. A client receives at least one message in a message database stored in a system memory, wherein the at least one message includes at least one attached file. The client displays a main preview of the at least one message, wherein the main preview of the at least one message includes an indicia that represents the at least one attached file. The client expands the main preview of the at least one message into a first sub-preview and a second sub-preview, wherein the first sub-preview represents the at least one message, and wherein the second sub-preview represents the at least one attached file. The client selects the second sub-preview to perform a function on the at least one attached file independent of the at least one message. The client performs the function on the at least one attached file independent of the at least one message.

It should be understood that at least some aspects of the present invention may alternatively be implemented in a computer-usable medium that contains a program product. Programs defining functions in the present invention can be delivered to a data storage system or a computer system via a variety of signal-bearing media, which include, without limitation, non-writable storage media (e.g., CD-ROM), writable storage media (e.g., hard disk drive, read/write CD-ROM, optical media), system memory such as, but not limited to random access memory (RAM), and communication media, such as computer networks and telephone networks, including Ethernet, the Internet, wireless networks, and like networks. It should be understood, therefore, that such signal-bearing media, when carrying or encoding computer-readable instructions that direct method functions in the present invention, represent alternative embodiments of the present invention. Further, it is understood that the present invention may be implemented by a system having means in the form of hardware, software, or a combination of software and hardware as described herein or their equivalent.

While the present invention has been particularly shown and described with reference to a preferred embodiment, it will be understood by those skilled in the art that various changes in form and detail may be made herein without departing from the spirit and scope of the invention.

What is claimed is:

1. A computer-implementable method for handling e-mail attachments in a data processing system, said computer-implementable method comprising:
displaying a main preview of said at least one message, wherein said main preview of said at least one message includes an indicia that represents said at least one attached file;
expanding said main preview of said at least one message into a first sub-preview and a second sub-preview, wherein said first sub-preview represents said at least one message, and wherein said second sub-preview represents said at least one attached file;
selecting said second sub-preview to perform a function on said at least one attached file independent of said at least one message; and
performing said function on said at least one attached file independent of said at least one message.

2. The computer-implementable method according to claim 1, further comprising:
receiving at least one message in a message database stored in a system memory, wherein said at least one message includes at least one attached file.

3. The computer-implementable method according to claim 2, further comprising:
sorting said at least one message in said message database by displaying only said second sub-preview.

4. The computer-implementable method according to claim 1, further comprising:
selecting said indicia to perform said function on said attached file independent of said message.

5. The computer-implementable method according to claim 1, wherein said function further comprises:
copying said attached file to another location in said data processing system.

6. The computer-implementable method according to claim 1, wherein said function further comprises:
deleting said attached file from said message database.

7. A system for handling e-mail attachments in a data processing system, said system comprising:
at least one processor;
a databus coupled to said at least one processor;
a computer-usable medium embodying computer program code, said computer program code comprising instructions executable by said at least one processor and configured for:
displaying a main preview of said at least one message, wherein said main preview of said at least one message includes an indicia that represents said at least one attached file;
expanding said main preview of said at least one message into a first sub-preview and a second sub-preview, wherein said first sub-preview represents said at least one message, and wherein said second sub-preview represents said at least one attached file;
selecting said second sub-preview to perform a function on said at least one attached file independent of said at least one message; and
performing said function on said at least one attached file independent of said at least one message.

8. The system according to claim 7, wherein said computer program code further comprises instructions configured for:
receiving at least one message in a message database stored in a system memory, wherein said at least one message includes at least one attached file.

9. The system according to claim 8, wherein said computer program code further comprises instructions configured for:
sorting said at least one message in said message database by displaying only said second sub-preview.

10. The system according to claim 7, wherein said computer program code further comprises instructions configured for:
selecting said indicia to perform said function on said attached file independent of said message.

11. The system according to claim 7, wherein said computer program code further comprises instructions configured for:
copying said attached file to another location in said data processing system.

12. The system according to claim 7, wherein said computer program code further comprises instructions configured for:
deleting said attached file from said message database.

13. A computer-usable medium embodying computer program code, said computer program code comprising computer executable instructions configured for:
displaying a main preview of said at least one message, wherein said main preview of said at least one message includes an indicia that represents said at least one attached file;
expanding said main preview of said at least one message into a first sub-preview and a second sub-preview, wherein said first sub-preview represents said at least one message, and wherein said second sub-preview represents said at least one attached file;
selecting said second sub-preview to perform a function on said at least one attached file independent of said at least one message; and
performing said function on said at least one attached file independent of said at least one message.

14. The computer-usable medium according to claim 13, wherein said embodied computer program code further comprises computer executable instructions configured for:
receiving at least one message in a message database stored in a system memory, wherein said at least one message includes at least one attached file.

15. The computer-usable medium according to claim 14, wherein said embodied computer program code further comprises computer executable instructions configured for:
sorting said at least one message in said message database by displaying only said second sub-preview.

16. The computer-usable medium according to claim 13, wherein said embodied computer program code further comprises computer executable instructions configured for:
selecting said indicia to perform said function on said attached file independent of said message.

17. The computer-usable medium according to claim 13, wherein said embodied computer program code further comprises computer executable instructions configured for:
copying said attached file to another location in said data processing system.

18. The computer-usable medium according to claim 13, wherein said embodied computer program code further comprises computer executable instructions configured for:
deleting said attached file from said message database.
